(19) United States
(12) Patent Application Publication
(10) Pub. No.: US 2023/0405590 A1
(43) Pub. Date: Dec. 21, 2023

(54) SAMPLE TRANSFER DEVICES, AND COMPONENTS AND METHODS THEREOF

(71) Applicant: GATTACO INC., Murrieta, CA (US)

(72) Inventors: Philip LUK, Murrieta, CA (US); Mahmoud ZUBAIDI, Murrieta, CA (US); Michael Ryan MCNEELY, Murrieta, CA (US)

(21) Appl. No.: 18/038,150

(22) PCT Filed: Nov. 22, 2021
(86) PCT No.: PCT/US21/60335

§ 371 Date: May 22, 2023

Related U.S. Application Data
(60) Provisional application No. 63/198,920, filed on Nov. 22, 2020.

(51) Int. Cl. B01L 3/00

(52) U.S. Cl. CPC B01L 3/50273; B01L 2300/0883; B01L 2200/025; B01L 2300/123; B01L 2400/0481; B01L 2200/0642

(57) ABSTRACT

Methods, devices and components are disclosed for transferring a sample, for example, for transferring purified biological samples and dispensing the purified sample into or onto rapid in-vitro diagnostic tests. The disclosed methods, devices and components can advantageously simplify the user interaction with the purification and dispensing device, ultimately leading to more accurate and repeatable results of the diagnostic test which, in turn, can lead to increased value and greater utilization of the test.

### CROSS-REFERENCE TO RELATED APPLICATIONS

This application claims priority to and the benefit of U.S. Provisional Patent Application No. 63/198,920, filed on Nov. 22, 2020. This and all other extrinsic materials discussed herein, including publications, patent applications, and patents, are incorporated by reference in their entirety. Where a definition or use of a term in an incorporated reference is inconsistent or contrary to the definition of that term provided herein, the definition of that term provided herein applies and the definition of the term in the reference does not apply.

### TECHNICAL FIELD

This disclosure relates to methods and devices for dispensing or transferring samples from one device to another.

### SUMMARY

In some aspects, a sample transfer device is provided, comprising a flexible channel member having a channel. The channel can have a proximal opening adapted to receive purified plasma from a purification device, and a distal opening adapted to discharge the purified plasma onto a sample receiving component of an assay device. The assay can be adapted to perform an assay based on the purified plasma, and can comprise any suitable assay, whether now known or later discovered. The flexible channel member can be adapted to accommodate surface irregularities or variations of a receiving surface of the sample receiving component. Irregularities or variations can comprise, for example, a curvature, an unevenness of height (e.g., a tilt or slant), a thickness, or a variation of thickness across a length of the sample receiving component.

The flexible channel member can comprise a base layer, a cover layer, and a channel layer positioned between the base layer and cover layer. Each of the layers can have a thickness of between 25-250 μm. The layers can be comprised of at least one of a silicone, an acrylic-based adhesive, a PET, a PETG, a PS, a PC, a PE, and a PMMA. The base layer can comprise a cut-out forming the distal opening of the channel. A transfer membrane can be provided, and can in some embodiments be positioned within the channel and above the distal opening. In some embodiments, a flexible transfer membrane can at least partially be positioned within the channel adjacent the distal opening, and the flexible transfer membrane can be adapted to be flexed to be in physical contact with the sample receiving component. The flexible transfer membrane can have any suitable thickness, including, for example, a thickness of between 25-250 μm. The flexible transfer membrane can be comprised of any suitable material(s), including, for example, at least one of a cellulose, a nitrocellulose, and a glass fiber.

The sample receiving component can comprise, among other things, a sample pad, nitrocellulose membrane, or a channel of an assay device. The receiving surface can comprise an upper surface (e.g., of a pad positioned below the distal opening), a side edge surface, an inlet of a channel of the assay device, or any other suitable surface of a sample receiving component.

In another aspect, a sample dispensing device is provided comprising a fluid containing component, which can be in fluid communication with a separation channel of a plasma purification device, or adapted or adaptable to be in fluid communication with a sample containing device (e.g., a separation channel of a plasma purification device).

In some embodiments, the sample containing device can be comprised of an upper film forming a portion of the fluid containing component, and a plunger positioned above the upper film and adapted to displace a fluid (e.g., air) contained in the fluid containing component upon actuation, and a ring-shaped shield positioned around the plunger to prevent premature actuation of the plunger. In some aspects, the plunger can further be adapted to cause the upper film to rupture upon actuation.

In some embodiments, the sample dispensing device has a fluid containing component that comprises a ring-shaped spacer having a first opening, an upper film over the opening, and a lower film below the opening. A fluid (e.g., a buffer) can be retained in the first opening between the upper film and the lower film, and the sample dispensing device can comprise a base comprising a second opening, wherein a depression of the upper film causes the lower film to rupture allowing the fluid to pass through the second opening. In some aspects, the upper film can be adapted to remain intact upon the depression of the upper film. In some aspects, the second opening can include a sharp point that rupture the lower film upon the depression of the upper film.

In yet another aspect, an indicator of a presence of liquid is provided. The indicator can comprise an absorbent member having a lower surface and an upper surface. The lower surface can have an ink printed thereon, wherein the presence of the liquid on the indicator causes a color of the ink to be more visible through the upper surface. In some aspects, a printed member having an ink printed thereon can be provided, wherein the absorbent member is positioned above the printed member, and wherein the presence of the liquid on the indicator causes a color of the ink to be more visible through the upper surface of the absorbent member. The absorbent member can comprise a hydrophilic paper having a thickness of 80-120 μm. A sample purification device can comprise the indicator. For example, the indicator can be positioned within a channel of the sample purification device. Additionally or alternatively, the indicator can contact an outlet of a channel of the sample purification device.

Other advantages and benefits of the disclosed devices, components and methods will be apparent to one of ordinary skill with a review of the following drawings and detailed description.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIGS. 1A-1C illustrate a sample transfer device according to an embodiment, comprising a flexible channel member and flexible transfer membrane, with FIG. 1C illustrating the sample transfer device used in connection with an assay;

FIGS. 2A-2B illustrates the top and bottom sides of a liquid contact indicator, useful for identifying when a liquid collection process has completed, according to an embodiment;

FIGS. 3A-3B illustrate layered and perspective assembled and exploded views of a liquid contact indicator and its positioning within a multi-layered laminate structure of a microfluidic device, according to an embodiment;

FIGS. 4A-4B illustrate perspective assembled and exploded views of a sample dispensing device used for dispensing a sample by manually depressing on the structure, which structure includes various safety features to minimize faulty operation, according to an embodiment;

FIGS. 5A-5B illustrates an alternative geometry in perspective assembled and exploded views of a sample dispensing device used for dispensing a sample followed by a reagent or buffer stored within the dispensing structure, according to an embodiment; and

FIG. 6 illustrates a sample dispensing device fluidly coupled with an inlet of a channel of a microfluidic device, according to an embodiment.

### DETAILED DESCRIPTION

After reading this description it will become apparent to one skilled in the art how to implement the disclosed devices, components and methods in various alternative embodiments and alternative applications. However, all the various embodiments of the present disclosure will not be described herein. It is understood that the embodiments presented here are presented by way of an example only, and not limitation. As such, this detailed description of various alternative embodiments should not be construed to limit the scope or breadth of the present disclosure as set forth below.

Rapid diagnostic tests, such as Lateral Flow Assays (LFA) are a common testing method intended for widespread use due to their relative simplicity and low cost. Despite their simplicity, they are not completely free of challenges for untrained users, which may limit their availability as determined by regulatory authorities. In addition, the clinical significance of the assay may also lead to restricted use by healthcare professionals only, who may guide the sample donor by explaining the significance of the test results and healthcare options, in particular if the results are not favorable.

Biosensors, such as graphene electrodes, chemFETs, biophotonics and other optical or electronic detectors designed to respond to the presence of a biomarker of interest, often claim superior sensitivity to laboratory sample analysis, the potential cost advantages made available by mass production of semiconductors, and ease of use associated with LFAs. However, so far very few have been commercialized successfully, despite these claims. The reason many fail to achieve commercial success, or success outside of a laboratory, often has to due with the challenges of obtaining a sample of sufficient quality or purity, so as to make the device report accurate results in a reliable and accurate manner.

The majority of clinical in-vitro diagnostics are performed in a laboratory where substantial sample preparation and purification equipment exists, and trained laboratory technicians are present to perform the sample purification and testing. With regard to blood testing, the vast majority of blood tests require plasma or serum and cannot work with whole blood directly, usually because the cellular components of the blood interfere with biomarker signal detection or complicate the flow of the sample through the analysis process. A centrifuge is commonly used to purify a blood sample to obtain plasma or serum.

In biosensor development, the developers are often very experienced in electronics, MEMS, semiconductor processing, sensor design and fabrication, digital signal processing, or similar field. Often, the need and importance of biological sample purification is not understood or greatly underestimated. Also, the commercial success of introducing new analysis devices and methods to the diagnostics market is far more difficult than most developers appreciate and is very price sensitive. Somewhere along the development process it is realized that the new technology may be more expensive than the cost of the same test as it currently exists in a laboratory setting. At this point the developers sometimes conclude they will have to develop their product for markets and commercial opportunities outside of a laboratory, sometimes referred to as near-patient testing, Point of Care (POC) Testing, or Point of Need (PON) testing, where higher insurance reimbursement or a higher market pricing are sometimes justified and paid. This is often when the challenges of sample purification in a non-laboratory setting finally become realized, frequently leading to project abandonment or opting to work with ‘simpler’ sample types, such as saliva or a respiratory sample mixed with buffer, rather than blood. However, saliva is classically understood as being a far poorer quality sample type, with common biomarkers not being present at all, or at greatly reduced concentrations than they may exist in plasma or serum. It is also difficult to develop quantitative biomarker diagnostics with saliva or similarly available sample, thereby further reducing the clinical value of this sample. Finally, since so many new diagnostic development projects eventually transition into working with these samples, with their limited biomarker options, the competition of commercialized products testing for the same biomarkers becomes very challenging, leading to frequent commercial failure.

LFAs are usually simple to use and inexpensive to manufacture. However, they have poor repeatability, poor consistency, and poor limits of detection. This is usually attributed to the inconsistency of liquid flow through the membranes and pads used in lateral flow device construction. The presence of dead-spots causing non-repeatable flow patterns, non-specific binding that is difficult to completely eliminate, the manual and often inconsistent addition of samples and buffers by the user, the difficulty of knowing the actual volume of sample reaching the analysis area, and other issues plague this diagnostic platform. These inconsistencies are well known in the industry, which has prompted many efforts at improvements such as by using some form of biosensor. The challenges of biosensor-based assay development have already been discussed.

The present disclosure recognizes the need for improved devices, components and methods for transferring a purified biological sample to a sample receiving component of an assay.

The disclosed technology details new devices, and components and methods thereof, for making a purified sample readily available for either LFAs, biosensors, or other rapid diagnostic platforms. The disclosed devices, components and methods remove many of the barriers that have limited the technical success and commercial availability of improved IVD products which, in turn, lead to improved, more equitable, and distributed rather than centralized healthcare services.

The method of blood sample purification employs a mechanism, detailed previously in earlier filings, described as capillary pressure re-set technology. This technology makes use of a soluble matrix that has a high enough capillarity, or capillary drawing force, to draw liquid through a hydrophilic purification membrane or filter under passive capillary forces, thereby eliminating the membrane's inherent breakthrough pressure, and then dissolving or disintegrating in the extracted liquid and releasing the liquid into a new geometry that has lower or less capillarity. This capability, in addition to other features and capabilities discussed in this disclosure, enables passive and automatic sample purification either in a separate pre-analytical sample processing tool, or with the purification function integrated with the analysis components of a testing device.

Since a purified blood sample, also known as plasma or serum, is fairly clear and transparent, especially in thin microfluidic channels that are used in the disclosed designs, it may be difficult for an untrained user to identify when the sample purification and collection process is complete. This is particularly important when the transfer of the purified sample into a diagnostic device, or downstream to the analysis region of an integrated device, is performed manually. To aid in identifying when the plasma or serum is ready to be transferred, details of the design and implementation of a ‘Process Completed’ indicator are described.

If a purified sample is to be transferred manually, such as by depressing an integrated dispensing bulb, a design is disclosed that aids in ensuring the dispensing is not actuated prematurely. In many LFA designs, the addition of a sample is often followed by the addition of a buffer or diluent at the same location. A design is described where the before mentioned integrated dispensing bulb also actuates the rupture and dispensing of a reagent pouch or blister pack that passes into the rapid testing platform immediately after the purified sample, by the same dispensing motion that passes the sample.

Sample Transfer Devices.

Previously disclosed capillary pressure re-set technology enables the rapid and automatic separation of plasma from whole blood. The separated plasma can also be metered to a precise volume, which is useful for many quantitative diagnostic testing applications. Sample collection and preparation is the first step in a normally three step diagnostic testing workflow and is often referred to as the Pre-Analytical step. The subsequent steps include sample analysis or biomarker detection, and then data processing or analysis and presentation or reporting.

An important consideration in the pre-analytical sample collection and purification component of the workflow, is how the prepared sample is passed downstream to the other workflow components. For example, a common means of transfer is for a purified sample to be pipetted into the diagnostic test. However, this may not be desirable or possible if the test is done outside of a lab, or if a trained operator is needed to pipette the sample properly. Improper pipetting or transfer of a sample into a diagnostic test can cause the test to fail or produce inaccurate results.

In an aspect of the inventive subject matter, a sample transfer device is provided, comprising a flexible channel member having a channel. The channel can have a proximal opening adapted to receive purified plasma from a purification device, and a distal opening adapted to discharge the purified plasma onto a sample receiving component (e.g., a sample pad, a membrane, or a channel) of an assay device. The sample receiving component can have a receiving surface, and the flexible channel member can be adapted to accommodate surface irregularities or variations of the receiving surface of the sample receiving component.

As used herein, the term “sample receiving component” should be interpreted broadly to include any sample pad, membrane, channel or other component of an assay device adapted to receive a sample, such as a lateral flow assay sample pad, a nitrocellulose membrane, or a channel of a microfluidic system of an assay device, and can be composed of cellulose, glass fiber, or other materials common in assay construction. The sample receiving component can be positioned below the distal opening, and in some embodiments, below a flexible transfer membrane adapted to be flexed to be in physical contact with the sample receiving component. An upper surface of the sample receiving component can comprise the receiving surface. In some aspects, the sample receiving component can be positioned adjacent the distal opening such that a purified sample flows from the purification device to a side edge of the sample receiving component. The side edge of the sample receiving component can comprise the receiving surface. A surface irregularity or variation can comprise, among other things, one or more of a curvature (e.g., a cross-sectional shape with side edges higher or lower than a non-edge portion), an unevenness of height (e.g., a slant or tilt, or a varying height across a length of the sample receiving component), or sample receiving components having different thicknesses. Differences in sample receiving components from the manufacturing process can be considered “irregularities” and intentional differences designed to be that way can be considered “variations”. Sample pads are specified to have a nominal thickness, such as 300 μm for a sample receiving pad and 60 μm for a nitrocellulose membrane, but may also vary by + or −20 to 100 μm or other amount, depending on which sample pad is being considered. The flexibility of the channel member, and in some embodiments, the transfer membrane, advantageously allows for complete and even contact between an outlet or transfer membrane of the sample transfer device and a receiving surface of the sample receiving component.

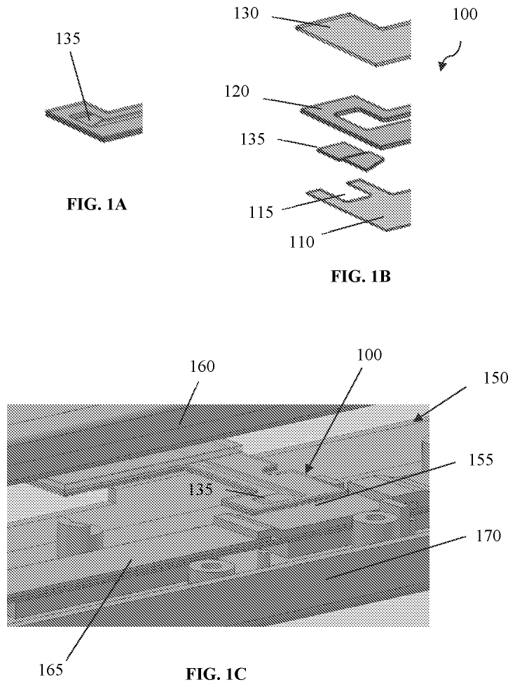

FIG. 1A-1B illustrate an embodiment of a sample transfer device 100 where a sample, prepared in a device (not shown), flows by capillary forces down a flexible flow channel. The flow channel is designed to be flexible by being comprised of thin, flexible layers, including a base layer 110 having a cutout 115 (or opening), a flexible transfer membrane 135, a channel layer 120, and a cover layer 130. Each layer may be comprised of flexible plastic film with adhesive that allows the layers to be bonded together. The layers may be, for example, about 1 to 10 mil thick, or 25 to 250 μm, depending on their specific function. Each of the flexible layers can be comprised of any suitable flexible material, including for example, at least one of a silicone, an acrylic-based adhesive, a Polyethylene Terephthalate (PET), a Polyethylene Terephthalate Glycol (PETG), a Polystyrene (PS), a Polycarbonate (PC)), Polyethylene (PE), and a Polymethyl Methacrylate (PMMA). The reason for the flexibility, similar to what may be described as a leaf-spring, is to allow the channel to conform, within a restricted range, to a downstream pad or membrane, such as a lateral flow assay sample pad or nitrocellulose membrane. These membranes are specified to have a nominal thickness, such as 300 μm for a sample receiving pad and 60 μm for a nitrocellulose membrane, but may also vary by + or −20 to 100μm, depending on which membrane is being considered. The flexibility ensures the outlet of the channel to be in a position that enables transfer of the sample to the membrane or pad, either automatically or by manual dispensing.

If the sample is to be transferred automatically, such as by capillary drawing forces of a lateral flow membrane in which it is in contact, the opening of the channel needs to be in the correct position along x, y, and z dimensions, and in physical contact with the membrane it is to be transferred into. This is complicated by the variable thickness of the pads or membranes with which it must interface.

Now turning to FIG. 1C, a non-limiting example of the assay device 150 is illustrated as including one or more sample receiving components 155 adapted to receive the purified plasma from a purification device, and an assay assembly 165 that performs at least one assay based on the purified plasma.

All suitable purification devices are contemplated, including, for example, the devices described in U.S. Pat. Nos. 10,532,325 and 10,870,085, which are incorporated herein in their entireties.

Assay Devices.

In some embodiments, the at least one assay is adapted to perform an assay based on purified plasma transferred via a sample transfer device 100, and is selected from the group consisting of Sodium assay, Potassium assay, Chloride assay, BUN/Urea assay, Glucose assay, Hematocrit assay, Ionized Calcium assay, PO2 assay, pH assay, PCO2 assay, Creatinine assay, Lactate assay, Celite ACT assay, Prothrombin Time PT/INR assay, Kaolin ACT assay, Cardiac Troponin I/cTnI assay, Total Carbon Dioxide/TCO2 assay, Creatine Kinase MB/CK-MB assay, and B-Type Natriuretic Peptide/BNP assay.

In some embodiment, the assay device performs an assay selected from the group consisting of SARS-COV-2 Antigen assay, anti-SARS-COV-2 Antibody assay, HbA1c assay, Albumin/Creatinine Ratio (ACR) urine assay, Insulin-like Growth Factor Binding Protein-1 (IGFBP-1) assay, phosphorylated IGFBP-1 assay, Wuchereria bancrofti antigen assay, G6PD enzyme assay, influenza A and B nucleoprotein antigens assay, Legionella pneumophila serogroup 1 antigen assay, Plasmodium antigens assay, respiratory syncytial virus (RSV) fusion protein antigen assay, Staphylococcus aureus assay, Streptococcus pyogenes Group A antigen assay, S. pneumoniae antigen assay, cholesterol assay, triglyceride assay, glucose assay, HIV assay, HIV-1/2 assay, Treponema pallidum antibody assay, LAM antigen (lipoarabinomannan) assay, HBsAg assay, human chorionic gonadotropin (hCG) assay, nuclear mitotic apparatus protein (NuMA) assay, penicillin binding protein 2a (PBP2a) assay, CD4 T-cell assay, BNP assay, CK-MB assay, d-dimer assay, myoglobin assay, NGAL assay, troponin I assay, qualitative TOX Drug Screen assay, H. pylori antibody assay, faecal occult blood assay, Plasmodium falciparum (P.f), Plasmodium vivax (P.v.), Plasmodium malariae (P.m) and Plasmodium ovale (P.o.) antigens assay, respiratory syncytial virus (RSV) assay, infectious mononucleosis heterophile antibodies assay, luteinizing hormone (LH) assay, Chlamydia trachomatis antigen assay, human anti-S. cerevisiaes antibodies assay, glutamate dehydrogenase (GDH) assay, C. difficile toxin B assay, Cryptosporidium oocyst antigens assay, Entamoeba histolytica adhesion assay, Giardia lamblia assay, Giardia cyst antigen assay, Cryptosporidium oocyst antigen assay, fecal lactoferrin assay, fecal VTEC/STEC toxins assay, cross-linked N-telopeptides of bone type I collagen (NTx) assay, arthropod-borne viruses assay, histone antibody assay, and Ribosomal P antibodies.

In some embodiments, the at least one assay is an HbA1c assay based on immunoassay or boronate affinity chromatograph.

In some embodiments, the at least one assay is selected from immunodiagnostic assays, DNA sequencing assays, bioluminescent assays, cell cytometry assays, and lateral flow assays.

Immunodiagnostic Assay

Immunodiagnostics is a diagnostic methodology that uses an antigen-antibody reaction as their primary means of detection. It is suitable for the detection of small amounts of (bio)chemical substances. Antibodies specific for a desired antigen can be conjugated with a radiolabel, fluorescent label, or color-forming enzyme and are used as a “probe” to detect it. Well known applications include pregnancy tests, immunoblotting, ELISA and immunohistochemical staining of microscope slides. The speed, accuracy and simplicity of such tests contribute to the development of rapid techniques for the diagnosis of disease, microbes and even illegal drugs in vivo (of course tests conducted in a closed environment have a higher degree of accuracy). Such testing is also used to distinguish compatible blood types.

In some embodiments, the immunodiagnostic assays are enzyme-linked immunosorbent assays (ELISA). The ELISA (sometimes also called an EIA) is a sensitive, inexpensive assay technique involving the use of antibodies coupled with indicators (e.g. enzymes linked to dyes) to detect the presence of specific substances, such as enzymes, viruses, or bacteria. While there are several different types, basically ELISAs are created by coating a suitable plastic (the solid phase) with an antibody. To complete the reaction, a sample believed to contain the antigen of interest is added to the solid phase. Then a second antibody coupled with an enzyme is used followed by the addition of a color-forming substrate specific to the antibody.

In some embodiments, the ELISA assay is based on comparison of color type, color intensity, or a combination thereof to one or more references. In some embodiments, the assay device comprises an optical device disposed for imaging or analyzing the ELISA assay, and optionally a display device for visualizing the image of the ELISA assay.

In some embodiments, the immunodiagnostic assays are lateral flow assays. Lateral flow tests also known as Lateral Flow Immunochromatographic Assays are simple devices intended to detect the presence (or absence) of a target analyte in sample (matrix) without the need for specialized and costly equipment, though many lab based applications exist that are supported by reading equipment. Typically, these tests are used for medical diagnostics either for home testing, point of care testing, or laboratory use. A widely spread and well known application is the home pregnancy test.

The lateral flow test is based on a series of capillary beds, such as pieces of porous paper or sintered polymer. Each of these elements has the capacity to transport fluid (e.g., urine) spontaneously. The first element (the sample pad) acts as a sponge and holds an excess of sample fluid. Once soaked, the fluid migrates to the second element (conjugate pad) in which the manufacturer has stored the so-called conjugate, a dried format of bio-active particles (see below) in a salt-sugar matrix that contains everything to guarantee an optimized chemical reaction between the target molecule (e.g., an antigen) and its chemical partner (e.g., antibody) that has been immobilized on the particle's surface. While the sample fluid dissolves the salt-sugar matrix, it also dissolves the particles and in one combined transport action the sample and conjugate mix while flowing through the porous structure. In this way, the analyte binds to the particles while migrating further through the third capillary bed. This material has one or more areas (often called stripes) where a third molecule has been immobilized by the manufacturer. By the time the sample-conjugate mix reaches these strips, analyte has been bound on the particle and the third ‘capture’ molecule binds the complex. After a while, when more and more fluid has passed the stripes, particles accumulate and the stripe-area changes color. Typically there are at least two stripes: one (the control) that captures any particle and thereby shows that reaction conditions and technology worked fine, the second contains a specific capture molecule and only captures those particles onto which an analyte molecule has been immobilized. After passing these reaction zones the fluid enters the final porous material that acts as a waste container. Lateral Flow Tests can operate as either competitive or sandwich assays.

In some embodiments, the lateral flow assay based on comparison of line intensity, line color, or a combination thereof to one or more reference lines. In some embodiments, the assay device comprises an optical device disposed for imaging or analyzing the lateral flow assay, and optionally a display device for visualizing the image of the lateral flow assay. A non-limiting example of a lateral flow assay sample is illustrated in FIG. 1C.

DNA Sequencing Assay.

In some embodiments, the DNA sequencing assays are based on DNA sequencing chips and wherein the assay device comprises interface to the DNA sequencing chip.

Genome sequencing is a costly but important tool in biomedical research used for the study of genetic disease and cancer. Common sequencing methods only sequence one or two DNA bases at a time in several cycles, which makes them costly to run in terms of time and reagents required. Recent development in this area includes a sequencing technique called sequencing by denaturation (SBD), which can be performed on a chip with a single integrated microfluidic device.

On the device, fluorescently labeled nucleotides are randomly incorporated into the DNA during replication. This results in fragments of different lengths, each labeled with a fluorescent molecule corresponding to its ending base type. Next these fragments are heated and, because shorter fragments have a lower melting temperature, sequentially denatured from the shortest fragment to the longest. By monitoring the decrease in fluorescence during this process, the signal can be analyzed to determine the base sequence of the target DNA template.

The technical features of SBD include the short sequencing run, low cost reagents and its ease of use. The device has the capability for performing high-speed fluorescence imaging while biomedical reactions occurs in a controlled manner. Due to its relative simplicity, SBD can bring down the cost of large-scale sequencing drastically.

Bioluminescence Assay.

In some embodiments, the at least one assay is a bioluminescence assay and wherein the assay device comprises an optical device for detecting bioluminescence, and a display device for visualizing the detected bioluminescence. In some embodiment, the bioluminescence assay is based on luciferase, which is a generic term for the class of oxidative enzymes used in bioluminescence and is distinct from a photoprotein.

In biological research, luciferase is commonly used as a reporter to assess the transcriptional activity in cells that are transfected with a genetic construct containing the luciferase gene under the control of a promoter of interest. Additionally proluminescent molecules that are converted to luciferin upon activity of a particular enzyme can be used to detect enzyme activity in coupled or two-step luciferase assays. Such substrates have been used to detect caspase activity and cytochrome P450 activity, among others.

Luciferase can also be used to detect the level of cellular ATP in cell viability assays or for kinase activity assays. Luciferase can act as an ATP sensor protein through biotinylation. Biotinylation will immobilize luciferase on the cell-surface by binding to a streptavidin-biotin complex. This allows luciferase to detect the efflux of ATP from the cell and will effectively display the real-time release of ATP through bioluminescence. Luciferase can additionally be made more sensitive for ATP detection by increasing the luminescence intensity through genetic modification.

One example of bioluminescence ATP assay is the ATP Bioluminescence Assay Kit CLS II by Roche Applied Science, which is specially developed for applications in which constant light signals are required for kinetic studies of enzymes and metabolic studies, or if coupled enzymatic assays are applied. If ATP determinations are manually started, the CLS Kit provides high reproducibility due to the constant signal generation. However, the sensitivity of the kit is lower by a factor of 10 as compared to the ATP Bioluminescence Assay Kit HS II, which is recommended for determinations in the high-sensitivity range. The ATP Bioluminescence Assay Kit HS II also contains an efficient cell lysis reagent, and can be used for the detection of ATP in microorganisms or animal cells. The ATP Bioluminescence Assay Kit CLS II has a Detection limit of 10-11 M ATP (10-15 moles), using a luminometer.

Cell Cytometry Assay.

In some embodiments, the at least one assay is a cell cytometry assay, and wherein the assay device comprises a micro-laser, a microcomputer, and an optical sensor.

Cell cytometry is a laser-based, biophysical technology employed in cell counting, cell sorting, biomarker detection and protein engineering, by suspending cells in a stream of fluid and passing them by an electronic detection apparatus. It allows simultaneous multiparametric analysis of the physical and chemical characteristics of up to thousands of particles per second. Flow cytometry is routinely used in the diagnosis of health disorders, especially blood cancers, but has many other applications in basic research, clinical practice and clinical trials. A common variation is to physically sort particles based on their properties, so as to purify populations of interest.

As a non-limiting example, a beam of light (usually laser light) of a single wavelength is directed onto a hydrodynamically focused stream of liquid. A number of detectors are aimed at the point where the stream passes through the light beam: one in line with the light beam (Forward Scatter or FSC) and several perpendicular to it (Side Scatter or SSC) and one or more fluorescence detectors. Each suspended particle from 0.2 to 150 micrometers passing through the beam scatters the ray, and fluorescent chemicals found in the particle or attached to the particle may be excited into emitting light at a longer wavelength than the light source. This combination of scattered and fluorescent light is picked up by the detectors, and, by analyzing fluctuations in brightness at each detector (one for each fluorescent emission peak), it is then possible to derive various types of information about the physical and chemical structure of each individual particle. FSC correlates with the cell volume and SSC depends on the inner complexity of the particle (i.e., shape of the nucleus, the amount and type of cytoplasmic granules or the membrane roughness). This is because the light is scattered off of the internal components of the cell. Some flow cytometers on the market have eliminated the need for fluorescence and use only light scatter for measurement. Other flow cytometers form images of each cell's fluorescence, scattered light, and transmitted light.

Fluorescence-activated cell sorting (FACS) is a specialized type of flow cytometry. It provides a method for sorting a heterogeneous mixture of biological cells into two or more containers, one cell at a time, based upon the specific light scattering and fluorescent characteristics of each cell. It is a useful scientific instrument, as it provides fast, objective and quantitative recording of fluorescent signals from individual cells as well as physical separation of cells of particular interest.

As a non-limiting example, the cell suspension is entrained in the center of a narrow, rapidly flowing stream of liquid. The flow is arranged so that there is a large separation between cells relative to their diameter. A vibrating mechanism causes the stream of cells to break into individual droplets. The system is adjusted so that there is a low probability of more than one cell per droplet. Just before the stream breaks into droplets, the flow passes through a fluorescence measuring station where the fluorescent character of interest of each cell is measured. An electrical charging ring is placed just at the point where the stream breaks into droplets. A charge is placed on the ring based on the immediately prior fluorescence intensity measurement, and the opposite charge is trapped on the droplet as it breaks from the stream. The charged droplets then fall through an electrostatic deflection system that diverts droplets into containers based upon their charge. In some systems, the charge is applied directly to the stream, and the droplet breaking off retains charge of the same sign as the stream. The stream is then returned to neutral after the droplet breaks off.

In addition to the ability to label and identify individual cells via fluorescent antibodies, cell cytometry can be used to measure cellular products such as cytokines, proteins, and other factors. Similar to ELISA sandwich assays, CBA assays use multiple bead populations typically differentiated by size and different levels of fluorescence intensity to distinguish multiple analytes in a single assay. The amount of the analyte captured is detected via a biotinylated antibody against a secondary epitope of the protein, followed by a streptavidin-R-phycoerythrin treatment. The fluorescent intensity of R-phycoerythrin on the beads is quantified on a flow cytometer equipped with a 488 nm excitation source. Concentrations of a protein of interest in the samples can be obtained by comparing the fluorescent signals to those of a standard curve generated from a serial dilution of a known concentration of the analyte.

In some embodiments, the at least one assay is an environmental assay selected from air quality assays, asbestos assays, water quality assays, soil content assays, or radon gas assays. In some embodiments, the at least one assay is an environmental assay and the assay device comprises gas chromatography (GC).

As illustrated in FIG. 1C, sample transfer device 100 can be used with an assay device 150, with an outlet 115 and transfer membrane 135 positioned above a sample receiving component 155 of assay device 150. In some aspects, transfer membrane 135 can comprise a step structure, with a first portion (lower step) being positioned below and adhered to a channel layer 120 of the sample transfer device, and a transfer portion (upper step) positioned within a channel of the transfer device 100, for example, above cut-out 115. A compressible pad may be provided located above the flexible channel of sample transfer device 100 and below an upper cartridge wall 160 of assay device 150. The compressible pad can ensure that the flexible channel and sample transfer device 100 does not overly compress sample receiving component 155 below it, for example, when the upper cartridge wall 160 and lower cartridge wall 170 are squeezed together. Over-compressing a sample receiving component in a lateral flow device can prevent proper transfer of sample to the device and flow of liquids within the device. Another feature which may prove useful is a transfer membrane 135 located within the channel of the sample transfer device 100, which can be adapted to be flexed to be in physical contact with the sample receiving component. For example, the transfer membrane 135 can be adapted to extend out of the outlet 115 and onto and in physical contact with the membrane below, aided by slight pressure from above such as what may be applied by a compressible pad. The transfer membrane can have any suitable thickness, including, for example, a thickness of between 25-250 μm, between 25-500 μm, or between 10-150 μm. The transfer membrane can be comprised of any suitable material, including for example, at least one of a cellulose, a nitrocellulose, and a glass fiber.

Liquid Contact Indicators and Process Complete Indicators.

If a purified sample is ready to be passed downstream, or is in the process of being transferred downstream, it may be useful for some indication to be given that this is the case. This may be particularly useful if the transfer is performed manually, such as by squeezing a dispensing bulb, or if some other action needs to be performed around the same time as the transfer of the sample. An example of this is that, in some lateral flow assays a buffer may be added in an upstream location from where the sample is added, but it should not be added until the sample has been added. An indication of the sample being transferred will provide the ‘signal’ that it is okay for the buffer to be added.

In some aspects, an indicator of a presence of a liquid is provided, comprising an absorbent member having a lower surface and an upper surface, wherein the lower surface has an ink printed thereon, and wherein the presence of the liquid on the indicator causes a color of the ink to be more visible through the upper surface. The indicator may be positioned on, for example, a sample purification device. For example, the sample purification device can comprise a channel, and the indicator can be positioned within the channel (e.g., at or adjacent an outlet), or positioned to contact the outlet.

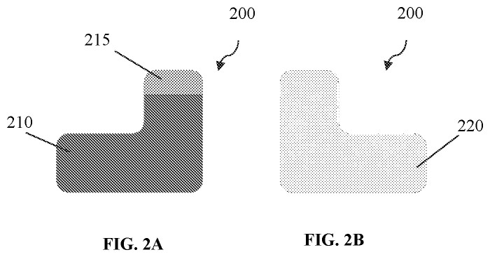

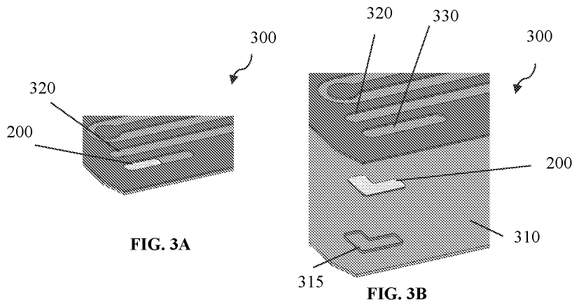

FIGS. 2A-2B illustrate a simple yet useful indicator that will change color when it becomes wet. In actuality it does not change color, but a color is printed on the bottom surface 210 of the indicator 200, usually paper, and the top surface 220 is unprinted and normally opaque and white, but becomes translucent or transparent when it becomes wet, thus allowing the color (e.g., of the ink printed) on the bottom surface to become visible. The top surface may dry and become opaque again, but usually not within the time frame that is important for the processing of the assay. The shape of the indicator is variable depending on the needs of the system. For example, the 1′ shaped design in FIGS. 2A-2B is useful for placement in a window area 330 of a sample purification device 300 having a flow channel with an outlet 320, as shown in FIG. 3, where the shorter arm of the 1′ can pass under an adhesive wall of the purification device and protrude into a flow channel having outlet 320, and the longer arm of the 1′ can extend into the window 330 of the device 300 and can be long enough to be easily visible by eye. The adhesive wall may be positioned in a recessed portion/cut-out 315 in a base layer 310 of device 300. The paper indicator 200 may also be a component of the bottom surface of a flow channel, rather than connecting to a separate window area where no liquid would flow.

Some preferred paper for indicators of the inventive subject matter may be hydrophilic, somewhat porous, and be thin enough to conform to an area where it is intended to be adhered, but thick enough so that it does not show the color that is printed on its bottom surface. In some preferred aspects, the paper also become transparent or translucent when wetted. A nominal thickness may be between 80-120 μm, or about 4 mils, or around 100 μm, with a paper weight of about 20 lbs, or 75 gsm. However, all suitable materials are contemplated where a color is more visible in the presence of a liquid. The ink should be able to penetrate the porous paper material, not be water soluble, and not flake-off when dry. In case it is somewhat water soluble the immediate area of the paper that extends into the flow channel 215 can be left unprinted, so no ink passes into the purified sample it comes in contact with.

In some aspects, an indicator of a presence of a liquid comprises an absorbent member having a lower surface and an upper surface, and a printed member separate from the absorbent member having an ink printed thereon. The absorbent member may be positioned above the printed member, and the presence of the liquid on the indicator causes a color of the ink to be more visible through the upper surface of the absorbent member.

Sample Dispensing Devices.

An integrated squeeze bulb is a useful means for dispensing a purified sample into a lateral flow assay, biosensor, or other rapid testing platform. However, care needs to be taken in the design and operation of the dispensing device that it is not prematurely actuated and that, once actuated, it dispenses the sample completely and does not inadvertently re-aspirate some of the sample back into the device or into the dispensing bulb area. The inventive subject matter provides sample dispensing devices, comprising a fluid containing component including an upper film, a plunger positioned above the upper film and adapted to displace a fluid contained in the fluid containing component upon actuation, and a shield positioned at least partially around the plunger to prevent premature actuation of the plunger. The fluid containing component can further include a ring-shaped base below the upper film, and wherein the ring-shaped base comprises an opening coupled to a channel member adapted to provide fluid communication between the dispensing bulb and a sample purification device (e.g., an inlet or a separation channel). In some aspects, the shield is ring-shaped and is positioned around an entire perimeter of the plunger. As used herein, the term “ring-shaped” includes circular, rounded, non-circular and non-rounded embodiments, for example, a rectangular or irregularly shaped component having a circular or non-circular opening extending therethrough. The plunger may be adapted to cause the upper film to rupture upon actuation.

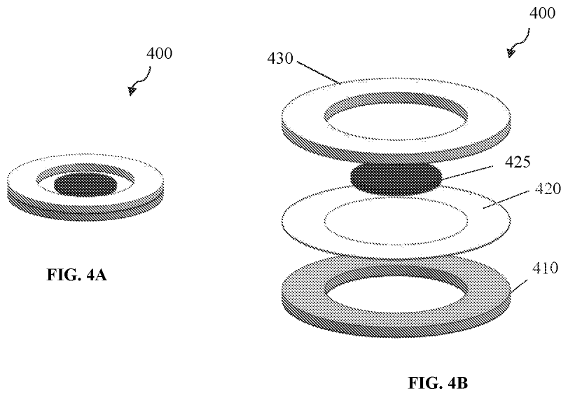

Now turning to FIGS. 4A-4B, a sample dispensing device 400 containing a fluid (e.g., air) is provided. Sample dispensing device 400 comprises a shield 430, which can comprise a plastic ring possibly having a thickness greater than a thickness of plunger 425, where a user's finger may rest rather than on the moveable component or plunger 425 of the device 400. The intent of the shield is to prevent inadvertent actuation. Actuation is performed by depressing the plunger 425 inside the shield, such as with the tip of the finger. The top surface of the shield 430 may be positioned slightly higher than the plunger 425 (e.g., 10-40 mils, or 0.25 to 1 mm above a top surface of the plunger). The plunger may be comprised of a rigid plastic material adhered to the surface of a film 420. The plunger can be adapted to cause the film 420 to rupture upon actuation. The rigidity of the plunger can offer tactile feedback as to the position of the finger during actuation. The film can be designed to have limited elastic deformation, well defined and repeatable plastic deformation, and a repeatable elongation leading to rupture. An aluminum foil film is an example of a film with these properties, such as one that is 0.7 mil, or 17.8 μm thick, with a tensile strength of about 11 KSI (kilopounds per square inch) and percent elongation of roughly 2.8%.

The properties of the foil (or other film), the diameter of the plunger, and the thickness and diameter of the opening of the base ring, dictate the stroke volume of fluid (e.g., air) displaced by depressing the plunger. This displaced air pushes liquid in the sample purification device or component, downstream. These dimensions and properties are also controlled to ensure the foil is plastically deformed to a point of rupture. Rupturing of the foil ensures no sample is sucked-back into the device by the vacuum forces that may be generated by the rebounding of elastic deformation, such as may exist if a foam component is used rather than rigid plastic and foil components.

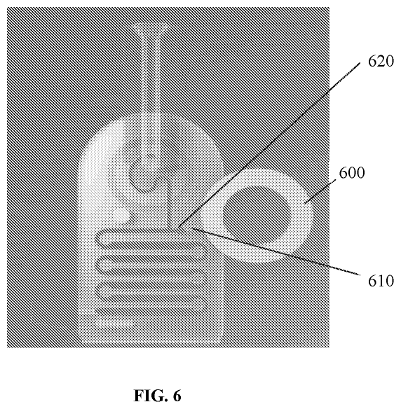

The inventive subject matter also provides a sample dispensing device, comprising a fluid retaining component including a spacer (e.g., a ring-shaped spacer) having a first opening, an upper film over the opening and a lower film below the opening. A fluid (e.g., a buffer) can be retained in the first opening between the upper film and the lower film. A suitable buffer may include, among other things, protease inhibitors, conjugate reagent important to the downstream assay, or biomarker target capture and enrichment beads. A base comprising a second opening is provided wherein a depression of the upper film causes the lower film to rupture allowing the fluid to pass through the second opening while the upper film can remain intact or unruptured. The second opening can include a sharp point or other feature that ruptures the lower film upon depression of the upper film. The second opening can be coupled to a channel member adapted to provide fluid communication between the dispensing bulb and a sample purification device (for example, as shown in FIG. 6).

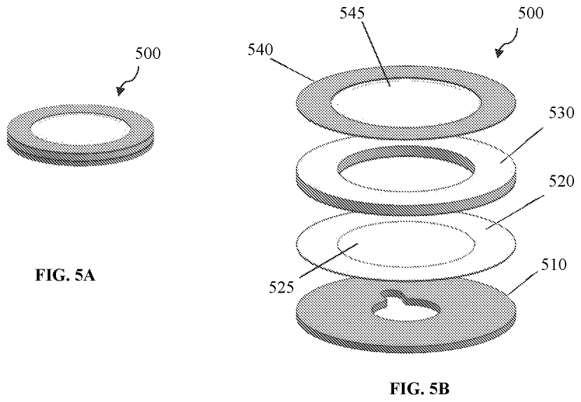

Now turning to FIGS. 5A-5B, a sample dispensing device 500 that can allow for the dispensing of an integrated liquid reagent or buffer that follows the purified sample out of the device or component is provided. Sample dispensing device 500 comprises a ring shaped spacer 530 having a first opening, an upper film 545 over opening 530, a lower film 525 under opening 530, wherein the opening, upper film and lower film form a fluid containing portion, and a base 510 comprising a second opening such that a depression of the upper film causes the lower film to rupture allowing the fluid to pass through the second opening while the upper film can remain intact or unruptured. In this design the beneficial features of protection against inadvertent dispensing, and prevention of suction-generated incomplete dispensing, are retained. Instead of a plunger (or in addition to a plunger), a thick metallic or mylar film can be used, held in place by a retention ring 540 and adhesive layers. Lower film 525 can be used, held in place by a retention ring 520. The rigidity of a non-compressible liquid retained in between non-elastic layers prevents inadvertent actuation. A buffer or other liquid reagent can be stored in the region enclosed by the reservoir spacer on the sides, the thick foil or mylar film on the top 545, and the thinner foil film on the bottom 525. These films can be held in place by adhesives or thermal bonding. When intentionally depressed, the top thick foil or mylar film (or other film) is pushed against the liquid contained in the blister or pouch, which, in turn, causes the bottom foil (or other film) to deform into the open area in the base 510. This deformation displaces the air contained in this region into the purification component, displacing liquid in the component to move downstream. By at least one of plastic deformation and sharp points within the central space of the base component, the bottom foil film eventually ruptures and, by continued finger pressure on the upper thick foil or mylar film, the liquid that was in the reservoir is pushed downstream into the channel connected to the sample purification device. This action dispenses the purified sample, followed by a small region of air, and then the liquid reagent or buffer, through the channels of the purification device and eventually, downstream into the assay.

Now turning to FIG. 6, a sample dispensing device 600 in fluid communication with a separation channel 620 of a sample purification device is illustrated. Here, sample dispensing device 600 is coupled with a channel member 610, which is coupled with a separation channel 620 (e.g., at an inlet) of a purification device. Sample dispensing device 600 can comprise any suitable dispensing device, including, for example, the devices described herein, a bulb dispenser, or a pipette bulb. The materials of the sample dispensing device can include any suitable material(s), including, for example, rigid plastics, such as ABS, PMMA or PC, and acrylic or silicone adhesive films, from 25 to 2,000 microns in thickness, as well as the Aluminum or other foil. Contemplated sample dispensing devices can be of any suitable size and shape. For example, sample dispensing devices of the inventive subject matter can have a circular shape with a nominal diameter of between 0.5 and 2 inches or between 0.5 and 1.25 inches, and a thickness of between 1-15 mm, between 1-10 mm, or between 1-5 mm. Viewed from another perspective, sample dispensing devices of the inventive subject matter can have a length of less than 5 inches or less than 3 inches, a width of less than 3 inches or less than 1.5 inches, and a height/thickness of less than 20 mm, less than 15 mm, or less than 10 mm.

### Non-Limiting Embodiments

Embodiment 1. A sample transfer device, comprising: a flexible channel member having a channel; wherein the channel has a proximal opening adapted to receive purified plasma from a purification device, and a distal opening adapted to discharge the purified plasma onto a sample receiving component of an assay device; and wherein the flexible channel member is adapted to accommodate surface irregularities of a receiving surface of the sample receiving component.

Embodiment 2. The sample transfer device of embodiment 1, wherein the sample receiving component is positioned below the distal opening.

Embodiment 3. The sample transfer device of embodiment 1, wherein the surface irregularity comprises a curvature.

Embodiment 4. The sample transfer device of embodiment 1, wherein the surface irregularity comprises an unevenness of height.

Embodiment 5. The sample transfer device of embodiment 1, wherein the surface irregularity comprises a sample receiving component thickness.

Embodiment 6. The sample transfer device of embodiment 1, wherein the surface irregularity comprises a variation of thickness across a length of the sample receiving component.

Embodiment 7. The sample transfer device of embodiment 1, wherein the flexible channel member comprises a base layer, a cover layer, and a channel layer positioned between the base layer and cover layer.

Embodiment 8. The sample transfer device of embodiment 7, wherein each of the base layer, cover layer, and channel layer has a thickness of between 25-250μm and is comprised of at least one of a silicone, an acrylic-based adhesive, a PET, a PETG, a PS, a PC, a PE, and a PMMA.

Embodiment 9. The sample transfer device of embodiment 7, wherein the base layer comprises a cut-out forming the distal opening of the channel.

Embodiment 10. The sample transfer device of embodiment 9, further comprises a transfer membrane with a first portion positioned within the channel and above the distal opening.

Embodiment 11. The sample transfer device of embodiment 1, further comprising a flexible transfer membrane at least partially positioned within the channel adjacent the distal opening, the flexible transfer membrane adapted to be flexed to be in physical contact with the sample receiving component.

Embodiment 12. The sample transfer device of embodiment 10 or embodiment 11, wherein the transfer membrane has a thickness of between 25-250 μm and is comprised of at least one of a cellulose, a nitrocellulose, and a glass fiber.

Embodiment 13. The sample transfer device of embodiment 1, wherein the assay device is adapted to perform an assay based on the purified plasma.

Embodiment 14. The sample transfer device of embodiment 13, wherein the assay is selected from the group consisting of immunodiagnostic assays, SARS-COV-2 Antigen assays, anti-SARS-COV-2 Antibody assays, DNA sequencing assays, bioluminescent assays, cell cytometry assays, and lateral flow assays.

Embodiment 15. The sample transfer device of embodiment 13, wherein the assay is selected from the group consisting of a Sodium assay, a Potassium assay, a Chloride assay, a BUN/Urea assay, a Glucose assay, a Hematocrit assay, a Ionized Calcium assay, a pO2 assay, a pH assay, a PCO2 assay, a Creatinine assay, a Lactate assay, a Celite ACT assay, a Prothrombin Time PT/INR assay, a Kaolin ACT assay, a Cardiac Troponin I/cTnI assay, a Total Carbon Dioxide/TCO2 assay, a Creatine Kinase MB/CK-MB assay, and a B-Type Natriuretic Peptide/BNP assay.

Embodiment 16. The sample transfer device of embodiment 13, wherein the assay is selected from the group consisting of a HbA1c assay, an Albumin/Creatinine Ratio (ACR) urine assay, an Insulin-like Growth Factor Binding Protein-1 (IGFBP-1) assay, a phosphorylated IGFBP-1 assay, a Wuchereria bancrofti antigen assay, a G6PD enzyme assay, influenza A and B nucleoprotein antigens assay, a Legionella pneumophila serogroup 1 antigen assay, a Plasmodium antigens assay, respiratory syncytial virus (RSV) fusion protein antigen assay, a Staphylococcus aureus assay, a Streptococcus pyogenes Group A antigen assay, a S. pneumoniae antigen assay, a cholesterol assay, a triglyceride assay, a glucose assay, a HIV assay, a HIV-1/2 assay, a Treponema pallidum antibody assay, a LAM antigen (lipoarabinomannan) assay, a HBsAg assay, a human chorionic gonadotropin (hCG) assay, a nuclear mitotic apparatus protein (NuMA) assay, a penicillin binding protein 2a (PBP2a) assay, a CD4 T-cell assay, a BNP assay, a CK-MB assay, a d-dimer assay, a myoglobin assay, a NGAL assay, a atroponin I assay, qualitative TOX Drug Screen assay, a H. pylori antibody assay, a faecal occult blood assay, a Plasmodium falciparum (P.f), Plasmodium vivax (P.v.), Plasmodium malariae (P.m) and Plasmodium ovale (P.o.) antigens assay, a respiratory syncytial virus (RSV) assay, a infectious mononucleosis heterophile antibodies assay, a luteinizing hormone (LH) assay, a Chlamydia trachomatis antigen assay, a human anti-S. cerevisiaes antibodies assay, a glutamate dehydrogenase (GDH) assay, a C. difficile toxin B assay, a Cryptosporidium oocyst antigens assay, a Entamoeba histolytica adhesion assay, a Giardia lamblia assay, a Giardia cyst antigen assay, a Cryptosporidium oocyst antigen assay, a fecal lactoferrin assay, a fecal VTEC/STEC toxins assay, a cross-linked N-telopeptides of bone type I collagen (NTx) assay, an arthropod-borne viruses assay, a histone antibody assay, and a Ribosomal P antibodies.

Embodiment 17. A sample transfer device, comprising: a flexible channel member having a channel; wherein the channel has a proximal opening adapted to receive purified plasma from a purification device, and a distal opening adapted to discharge the purified plasma onto a sample receiving component of an assay device; and wherein the flexible channel member is adapted to accommodate surface variations of a receiving surface of the sample receiving component.

Embodiment 18. The sample transfer device of embodiment 17, wherein the sample receiving component is positioned below the distal opening.

Embodiment 19. The sample transfer device of embodiment 17, wherein the surface variations comprises a curvature.

Embodiment 20. The sample transfer device of embodiment 17, wherein the surface variations comprises an unevenness of height.

Embodiment 21. The sample transfer device of embodiment 17, wherein the surface variations comprises a sample receiving component thickness.

Embodiment 22. The sample transfer device of embodiment 17, wherein the surface variations comprises a variation of thickness across a length of the sample receiving component.

Embodiment 23. The sample transfer device of embodiment 17, wherein the flexible channel member comprises a base layer, a cover layer, and a channel layer positioned between the base layer and cover layer.

Embodiment 24. The sample transfer device of embodiment 23, wherein each of the base layer, cover layer, and channel layer has a thickness of between 25-250 μm and is comprised of at least one of a silicone, an acrylic-based adhesive, a PET, a PETG, a PS, a PC, and a PMMA.

Embodiment 25. The sample transfer device of embodiment 23, wherein the base layer comprises a cut-out forming the distal opening of the channel.

Embodiment 26. The sample transfer device of embodiment 25, further comprises a transfer membrane with a first portion positioned within the channel and above the distal opening.

Embodiment 27. The sample transfer device of embodiment 17, further comprising a flexible transfer membrane at least partially positioned within the channel adjacent the distal opening, the flexible transfer membrane adapted to be flexed to be in physical contact with the sample receiving component.

Embodiment 28. The sample transfer device of embodiment 26 or embodiment 27, wherein the transfer membrane has a thickness of between 25-250 μm and is comprised of at least one of a cellulose, a nitrocellulose, and a glass fiber.

Embodiment 29. The sample transfer device of embodiment 17, wherein the assay device is adapted to perform an assay based on the purified plasma.

Embodiment 30. The sample transfer device of embodiment 29, wherein the assay is selected from the group consisting of immunodiagnostic assays, DNA sequencing assays, bioluminescent assays, cell cytometry assays, and lateral flow assays.

Embodiment 31. The sample transfer device of embodiment 29, wherein the assay is selected from the group consisting of a Sodium assay, a Potassium assay, a Chloride assay, a BUN/Urea assay, a Glucose assay, a Hematocrit assay, a Ionized Calcium assay, a pO2 assay, a pH assay, a PCO2 assay, a Creatinine assay, a Lactate assay, a Celite ACT assay, a Prothrombin Time PT/INR assay, a Kaolin ACT assay, a Cardiac Troponin I/cTnI assay, a Total Carbon Dioxide/TCO2 assay, a Creatine Kinase MB/CK-MB assay, and a B-Type Natriuretic Peptide/BNP assay.

Embodiment 32. The sample transfer device of embodiment 29, wherein the assay is selected from the group consisting of a HbA1c assay, an Albumin/Creatinine Ratio (ACR) urine assay, an Insulin-like Growth Factor Binding Protein-1 (IGFBP-1) assay, a phosphorylated IGFBP-1 assay, a Wuchereria bancrofti antigen assay, a G6PD enzyme assay, influenza A and B nucleoprotein antigens assay, a Legionella pneumophila serogroup 1 antigen assay, a Plasmodium antigens assay, respiratory syncytial virus (RSV) fusion protein antigen assay, a Staphylococcus aureus assay, a Streptococcus pyogenes Group A antigen assay, a S. pneumoniae antigen assay, a cholesterol assay, a triglyceride assay, a glucose assay, a HIV assay, a HIV-1/2 assay, a Treponema pallidum antibody assay, a LAM antigen (lipoarabinomannan) assay, a HBsAg assay, a human chorionic gonadotropin (hCG) assay, a nuclear mitotic apparatus protein (NuMA) assay, a penicillin binding protein 2a (PBP2a) assay, a CD4 T-cell assay, a BNP assay, a CK-MB assay, a d-dimer assay, a myoglobin assay, a NGAL assay, a atroponin I assay, qualitative TOX Drug Screen assay, a H. pylori antibody assay, a faecal occult blood assay, a Plasmodium falciparum (P.f), Plasmodium vivax (P.v.), Plasmodium malariae (P.m) and Plasmodium ovale (P.o.) antigens assay, a respiratory syncytial virus (RSV) assay, a infectious mononucleosis heterophile antibodies assay, a luteinizing hormone (LH) assay, a Chlamydia trachomatis antigen assay, a human anti-S. cerevisiaes antibodies assay, a glutamate dehydrogenase (GDH) assay, a C. difficile toxin B assay, a Cryptosporidium oocyst antigens assay, a Entamoeba histolytica adhesion assay, a Giardia lamblia assay, a Giardia cyst antigen assay, a Cryptosporidium oocyst antigen assay, a fecal lactoferrin assay, a fecal VTEC/STEC toxins assay, a cross-linked N-telopeptides of bone type I collagen (NTx) assay, an arthropod-borne viruses assay, a histone antibody assay, and a Ribosomal P antibodies.

Embodiment 33. A sample dispensing device, comprising: a fluid containing component including an upper film; a plunger positioned above the upper film and adapted to displace a fluid contained in the fluid containing component upon actuation; and a ring-shaped shield positioned around the plunger to prevent premature actuation of the plunger.

Embodiment 34. The sample dispensing device of embodiment 33, wherein the plunger is further adapted to cause the upper film to rupture upon actuation.

Embodiment 35. The sample dispensing device of embodiment 33, wherein the fluid is air.

Embodiment 36. The sample dispensing device of embodiment 33, wherein the fluid containing component further includes a ring-shaped base below the upper film, and wherein the ring-shaped base comprises an opening coupled to a channel member adapted to provide fluid communication between the dispensing bulb and a sample purification device.

Embodiment 37. A sample dispensing device, comprising: a fluid retaining component including a ring-shaped spacer having a first opening, an upper film over the opening and a lower film below the opening; a fluid retained in the first opening between the upper film and the lower film; and a base comprising a second opening, wherein a depression of the upper film causes the lower film to rupture allowing the fluid to pass through the second opening.

Embodiment 38. The sample dispensing device of embodiment 37, wherein the fluid comprises a buffer.

Embodiment 39. The sample dispensing device of embodiment 37, wherein the upper film remains intact upon the depression of the upper film.

Embodiment 40. The sample dispensing device of embodiment 37, wherein the second opening is coupled to a channel member adapted to provide fluid communication between the dispensing bulb and a sample purification device.

Embodiment 41. The sample dispensing device of embodiment 37, wherein the second opening includes a sharp point that ruptures the lower film upon the depression of the upper film.

Embodiment 42. A sample dispensing device, comprising: a fluid containing component in fluid communication with a separation channel of a plasma purification device.

Embodiment 43. The sample dispensing device of embodiment 42, further comprising: an upper film forming a portion of the fluid containing component; a plunger positioned above the upper film and adapted to displace a fluid contained in the fluid containing component upon actuation; and a ring-shaped shield positioned around the plunger to prevent premature actuation of the plunger.

Embodiment 44. The sample dispensing device of embodiment 43, wherein the plunger is further adapted to cause the upper film to rupture upon actuation.

Embodiment 45. The sample dispensing device of embodiment 43, wherein the fluid is air.

Embodiment 46. The sample dispensing device of embodiment 42, wherein the fluid containing component comprises a ring-shaped spacer having a first opening, an upper film over the opening and a lower film below the opening.

Embodiment 47. The sample dispensing device of embodiment 46, further comprising: a fluid retained in the first opening between the upper film and the lower film; and a base comprising a second opening, wherein a depression of the upper film causes the lower film to rupture allowing the fluid to pass through the second opening.

Embodiment 48. The sample dispensing device of embodiment 47, wherein the fluid comprises a buffer.

Embodiment 49. The sample dispensing device of embodiment 47, wherein the upper film remains intact upon the depression of the upper film.

Embodiment 50. The sample dispensing device of embodiment 47, wherein the second opening includes a sharp point that ruptures the lower film upon the depression of the upper film.

Embodiment 51. An indicator of a presence of a liquid, comprising: an absorbent member having a lower surface and an upper surface; wherein the lower surface has an ink printed thereon; and wherein the presence of the liquid on the indicator causes a color of the ink to be more visible through the upper surface.

Embodiment 52. A sample purification device, comprising the indicator of embodiment 51.

Embodiment 53. The sample purification device of embodiment 52, wherein the sample purification device comprises a channel, and wherein the indicator is positioned within the channel.

Embodiment 54. The sample purification device of embodiment 52, wherein the sample purification device comprises a channel having an outlet, and wherein a portion of the indicator contacts the outlet.

Embodiment 55. The indicator of embodiment 51, wherein the absorbent member is a hydrophilic paper having a thickness of 80-120μm.

Embodiment 56. An indicator of a presence of a liquid, comprising: an absorbent member having a lower surface and an upper surface; a printed member having an ink printed thereon; wherein the absorbent member is positioned above the printed member; and wherein the presence of the liquid on the indicator causes a color of the ink to be more visible through the upper surface of the absorbent member.

Embodiment 57. A sample purification device, comprising the indicator of embodiment 56.

Embodiment 58. The sample purification device of embodiment 57, wherein the sample purification device comprises a channel, and wherein the indicator is positioned within the channel.

Embodiment 59. The sample purification device of embodiment 57, wherein the sample purification device comprises a channel having an outlet, and wherein a portion of the indicator contacts the outlet.

Embodiment 60. The indicator of embodiment 56, wherein the absorbent member is a hydrophilic paper having a thickness of 80-120 μtm.

Thus, specific examples of sample transfer devices, components and methods thereof have been disclosed. It should be apparent, however, to those skilled in the art that many more modifications besides those already described are possible without departing from the inventive concepts herein. While examples and variations of the many aspects of the inventive subject matter have been disclosed and described herein, such disclosure is provided for purposes of explanation and illustration only. Thus, various changes and modifications may be made without departing from the scope of the claims. The examples herein are not meant to be limiting in any way in converting the principles discussed in this disclosure into physical form, and are not necessarily to scale as may be used in a physical system. Like reference numerals refer to like parts in different views or embodiments. There are, in fact, many possible liquids that may be processed, many possible membrane or microchannel configurations, housings, flow systems, entrance and exit point designs, flow patterns, soluble matrix placements, dimensions and geometries, and liquid flow driving forces possible in various embodiments.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

The terminology used herein is for the purpose of describing particular cases only and is not intended to be limiting. The below terms are discussed to illustrate meanings of the terms as used in this specification, in addition to the understanding of these terms by those of skill in the art. As used herein and in the appended claims, the singular forms “a,” “an,” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

Reference throughout this specification to “an embodiment” or “an implementation” means that a particular feature, structure, or characteristic described in connection with the embodiment is included in at least one embodiment or implementation. Thus, appearances of the phrases “in an embodiment” in various places throughout this specification are not necessarily all referring to the same embodiment or a single exclusive embodiment. Furthermore, the particular features, structures, or characteristics described herein may be combined in any suitable manner in one or more embodiments or one or more implementations.

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the inventive subject matter and does not pose a limitation on the scope of the disclosure otherwise claimed. No language in the specification should be construed as indicating any non-claimed element essential to the practice of the inventive subject matter.

Certain numerical values and ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

What is claimed is:

1. A sample transfer device, comprising:
a flexible channel member having a channel;
wherein the channel has a proximal opening adapted to receive purified plasma from a purification device, and a distal opening adapted to discharge the purified plasma onto a sample receiving component of an assay device; and
wherein the flexible channel member is adapted to accommodate surface irregularities or variations of a receiving surface of the sample receiving component.

2. The sample transfer device of claim 1, wherein the sample receiving component is positioned below the distal opening.

3. The sample transfer device of claim 1, wherein the surface irregularities or variations comprises a curvature.

4. The sample transfer device of claim 1, wherein the surface irregularities or variations comprises an unevenness of height.

5. (canceled)

6. The sample transfer device of claim 1, wherein the surface irregularities or variations comprises a variation of thickness across a length of the sample receiving component.

7. The sample transfer device of claim 1, wherein the flexible channel member comprises a base layer, a cover layer, and a channel layer positioned between the base layer and cover layer.

8. The sample transfer device of claim 7, wherein each of the base layer, cover layer, and channel layer has a thickness of between 25-250 μm and is comprised of at least one of a silicone, an acrylic-based adhesive, a PET, a PETG, a PS, a PC, a PE, and a PMMA.

9. The sample transfer device of claim 7, wherein the base layer comprises a cut-out forming the distal opening of the channel.

10. The sample transfer device of claim 9, further comprises a transfer membrane with a first portion positioned within the channel and above the distal opening.

11. The sample transfer device of claim 1, further comprising a flexible transfer membrane at least partially positioned within the channel adjacent the distal opening, the flexible transfer membrane adapted to be flexed to be in physical contact with the sample receiving component.

12. The sample transfer device of claim 10, wherein the transfer membrane has a thickness of between 25-250 μm and is comprised of at least one of a cellulose, a nitrocellulose, and a glass fiber.

13. (canceled)

14. (canceled)

15. (canceled)

16. (canceled)

17. A sample dispensing device, comprising:
a fluid containing component in fluid communication with a separation channel of a plasma purification device.

18. The sample dispensing device of claim 17, further comprising:
an upper film forming a portion of the fluid containing component;
a plunger positioned above the upper film and adapted to displace a fluid contained in the fluid containing component upon actuation; and
a ring-shaped shield positioned around the plunger to prevent premature actuation of the plunger.

19. The sample dispensing device of claim 18, wherein the plunger is further adapted to cause the upper film to rupture upon actuation.

20. The sample dispensing device of claim 18, wherein the fluid is air.

21. The sample dispensing device of claim 17, wherein the fluid containing component comprises a ring-shaped spacer having a first opening, an upper film over the opening and a lower film below the opening.

22. The sample dispensing device of claim 21, further comprising:
a fluid retained in the first opening between the upper film and the lower film; and
a base comprising a second opening, wherein a depression of the upper film causes the lower film to rupture allowing the fluid to pass through the second opening.

23. The sample dispensing device of claim 22, wherein the fluid comprises a buffer.

24. The sample dispensing device of claim 22, wherein the upper film remains intact upon the depression of the upper film.

25. The sample dispensing device of claim 22, wherein the second opening includes a sharp point that ruptures the lower film upon the depression of the upper film.
